(19) United States
(12) Patent Application Publication
(10) Pub. No.: US 2024/0166789 A1
(43) Pub. Date: May 23, 2024

(54) CONJUGATED DIENE BASED COPOLYMER, RUBBERS AND MANUFACTURING METHODS THEREOF

(71) Applicant: TSRC Corporation, Kaohsiung City (TW)

(72) Inventors: Chun-Lin Chen, Kaohsiung City (TW); Yun-Ta Lee, Kaohsiung City (TW)

(73) Assignee: TSRC Corporation, Kaohsiung City (TW)

(21) Appl. No.: 18/512,502

(22) Filed: Nov. 17, 2023

Related U.S. Application Data
(60) Provisional application No. 63/426,210, filed on Nov. 17, 2022.

(51) Int. Cl. C08F 236/10; B60C 1/00; C08L 9/06

(52) U.S. Cl. CPC C08F 236/10; B60C 1/00; C08L 9/06

(57) ABSTRACT

The present invention provides a conjugated diene based rubber comprising a conjugated diene based copolymer comprising at least two conjugated diene monomer units and optionally comprising a vinyl aromatic hydrocarbon monomer unit, wherein the conjugated diene based copolymer comprises a first block composed of a first conjugated diene monomer unit and the vinyl aromatic hydrocarbon monomer unit or a second conjugated diene monomer unit, the second conjugated diene monomer unit being distinct from the first conjugated diene monomer unit, the first block being random; and a second block, comprising at least the second conjugated diene monomer unit and optionally comprising the vinyl aromatic hydrocarbon monomer unit, wherein the first block is connected to the second block, and the amount of the vinyl aromatic hydrocarbon monomer units or the second conjugated diene monomer units is at least 35 wt % of the first block.

### CROSS-REFERENCE TO RELATED APPLICATIONS

This application is a non-provisional of, and claims priority to and the benefit of, U.S. Provisional Patent Application No. 63/426,210, filed Nov. 17, 2022 and entitled “CONJUGATED DIENE BASED COPOLYMER, RUBBERS AND MANUFACTURING METHODS THEREOF,” which is hereby incorporated by reference herein.

### FIELD OF INVENTION

The present invention relates to a conjugated diene based rubber, in particular a conjugated diene based rubber comprising a conjugated diene based copolymer composed of a conjugated diene monomer unit and optionally comprising a vinyl aromatic hydrocarbon monomer unit.

### BACKGROUND OF THE DISCLOSURE

With the recent need to decrease in fuel consumption of automobiles, the demand for rubber materials for tires has increased. Due to having good rolling resistance and abrasion resistance, conjugated diene based rubbers are increasingly required in tire applications. The industry has proposed the addition of silica mixture as a reinforcing agent to conjugated diene based rubber used in tires. Tire treads containing silica mixture have preferred rolling resistance and resistance to wet sliding, resulting in better running stability.

However, conjugated diene based rubbers containing silica obtained by existing technologies inevitably has various problems. Therefore, there is a continuing need for novel conjugated diene based rubbers to meet application requirements.

### SUMMARY OF THE DISCLOSURE

### The Problem to be Solved

The present invention has found that the prior art has a limited selection of conjugated diene based rubbers, and in particular, a limited variety of conjugated diene-based rubbers with well-balanced properties such as tensile strength at break (Tb), elongation at break (Eb), abrasion resistance (DIN), and rolling resistance (R.R.), and there is thus room for development.

### Problem Solving Technical Solutions and Their Effectiveness Compared to Prior Art

The present invention unexpectedly found that the conjugated diene monomer units with side chains present in the conjugated diene based rubber have a great influence on the overall viscosity of the conjugated diene based copolymer and the conjugated diene based rubber. The side chain herein is defined as a group with a carbon number greater than or equal to 3. If the distribution of the conjugated diene monomer units with side chains in the conjugated diene based copolymer chain is too concentrated in a certain section, it will cause a problem of insufficient viscosity. If the distribution of conjugated diene monomer unit with side chain in the conjugated diene based rubber chain is too dispersed, the overall viscosity of the conjugated diene based rubber will also be reduced. Both above will affect the compatibility between conjugated diene based rubber and silica or silica and carbon black.

As a result of numerous experimental studies, the present invention has elaborated a conjugated diene based rubber comprising a conjugated diene based polymer having at least two blocks and/or the conjugated diene based polymer being further modified, wherein at least one of the two blocks is a random block.

The present invention utilizes at least two blocks to appropriately coordinate the position of the side-chained conjugated diene monomer unit located in the conjugated diene based polymer. The random distribution of the side-chained conjugated diene monomer units in the random block allows the conjugated diene based polymer to be locally dispersed rather than concentrated. The absence of side-chained conjugated diene monomer units in the other block allows the conjugated diene based polymer as a whole to appear locally concentrated with side-chained conjugated diene monomer units. The length of the two blocks can be adjusted appropriately to solve the above problem. The conjugated diene based rubber of the present invention has embodiments that contain vinyl aromatic hydrocarbon monomer units and embodiments that do not contain vinyl aromatic hydrocarbon monomer units. In one embodiment, the other block without the side-chained conjugated diene monomer unit has only a single monomer unit. In another embodiment, both blocks are random. In a further embodiment, the random block with the side-chained conjugated diene monomer unit contains the vinyl aromatic hydrocarbon monomer unit but doesn't contain the other conjugated diene monomer unit. In a further embodiment, the random block with the side-chained conjugated diene monomer unit contains the other conjugated diene monomer unit but does not contain the vinyl aromatic hydrocarbon monomer unit.

In addition, the present invention also unexpectedly found that the synthesis time for synthesizing random blocks (mixture of the side-chained conjugated diene monomer unit and the other conjugated diene monomer unit or the vinyl aromatic hydrocarbon monomer unit, and the amount of the other conjugated diene monomer units or the vinyl aromatic hydrocarbon monomer units in the random block is at least 35 wt % of the random block) is much faster than that for synthesizing homopolymerized blocks with side-chained conjugated diene monomer units, and thus there is an advantage of shortening the time and increasing the yield.

The present invention further includes other technical solutions and their effectiveness, which are described hereafter.

Descriptions of well-known components, materials, and process techniques are omitted so as to not unnecessarily obscure the embodiments of the invention.

### DETAILED DESCRIPTION OF EXEMPLARY EMBODIMENTS

### Conjugated Diene Based Copolymer and Conjugated Diene Based Rubber

The present invention provides a conjugated diene based rubber having a conjugated diene based copolymer comprising at least two conjugated diene monomer units and optionally comprising a vinyl aromatic hydrocarbon monomer unit, wherein the conjugated diene based copolymer comprises a first block composed of a first conjugated diene monomer unit and the vinyl aromatic hydrocarbon monomer unit or a second conjugated diene monomer unit, the second conjugated diene monomer unit being distinct from the first conjugated diene monomer unit, the first block being random; and a second block, comprising at least the second conjugated diene monomer unit and optionally comprising the vinyl aromatic hydrocarbon monomer unit, wherein the first block is connected to the second block, and the amount of the vinyl aromatic hydrocarbon monomer units or the second conjugated diene monomer units in the first block is at least 35 wt % of the first block.

The second conjugated diene monomer unit is that which, upon polymerization, does not result in a side chain having an alkyl or alkenyl group with a carbon number greater than or equal to 3, for example, from the following monomers: 1,3-butadiene, 2-chloro-1,3-butadiene and any combination thereof. Preferably 1,3-butadiene is used (all references to butadiene herein are to 1,3-butadiene).

The first conjugated diene monomer unit is that having a side chain that the second conjugated diene monomer unit does not have after polymerization and the side chain is with carbon number greater than or equal to 3, for example, from the following monomers: 1,3-pentadiene, 1,3-hexadiene, 1,3-heptadiene, 2-methyl-1,3-butadiene (isoprene), 2-methyl-1, 3-pentadiene, 2-hexyl-1,3-butadiene, 2-phenyl-1,3-butadiene, 2-phenyl-1,3-pentadiene, 2-p-phenyl-1,3-butadiene, 2-benzyl-1,3-butadiene, 3-methyl-1,3-pentadiene, 3-methyl-1,3-hexadiene, 3-butyl-1,3-octadiene, 3-phenyl-1,3-pentadiene, 4-methyl-1,3-pentadiene, 1,4-diphenyl-1,3-butadiene, 2,3-dimethyl-1,3-butadiene, 2,3-dimethyl-1,3-pentadiene, 2,3-dibenzyl-1,3-butadiene, 4,5-diethyl-1,3-octadiene, and any combination thereof. The side chain carbon number equal to 3 is preferred. Preferably isoprene is used.

The vinyl aromatic hydrocarbon monomer unit, for example, is from the following monomers: styrene, methylstyrene and all isomers thereof, ethylstyrene and all isomers thereof, tert-butylstyrene and all isomers thereof, dimethylstyrene and all isomers thereof, methane oxystyrene and all isomers thereof, cyclohexylstyrene and all isomers thereof, vinylbiphenyl, 1-vinyl-5-hexylnaphthalene, vinylnaphthalene, vinylanthracene, 2,4-diisopropylstyrene, 5-tert-butyl-2-methylstyrene, divinylbenzene, trivinylbenzene, divinylnaphthalene, tert-butoxystyrene, 4-propylstyrene, 4-dodecylstyrene, 2-ethyl-4-benzylstyrene, 4-(phenylbutyl)styrene, N-(4-vinylbenzyl)-N,N-dimethylamine, (4-vinylphenyl)dimethylaminoethyl ether, N,N-dimethylaminoethylstyrene, N,N-dimethylaminomethylstyrene, N,N-diethylaminomethylstyrene, N,N-diethylaminoethylstyrene, vinyl xylene, vinylpyridine, diphenylethylene, 2,4,6-trimethylstyrene, α-methyl-2,6-dimethylstyrene, α-methyl-2,4-dimethylstyrene, β-methyl-2,6-dimethylstyrene, ß-methyl-2,4-dimethylstyrene, indene, diphenylethylene containing tertiary amino groups, such as 1-(4-N,N-dimethylaminophenyl)-1-phenylethylene, and any combinations thereof. Preferably styrene is used. In a preferred embodiment the first conjugated diene monomer unit is from isoprene, the second conjugated diene monomer unit is from butadiene, and the vinyl aromatic hydrocarbon monomer unit is from styrene.

The first block is random which means that the first block contains at least two different monomer units dispersed and arranged by chance within the first block.

In one embodiment, the present invention provides the conjugated diene based rubber as described hereinabove, wherein the first conjugated diene monomer unit is present only in the first block.

In one embodiment, the present invention provides the conjugated diene based rubber as described hereinabove, wherein the percentage of the first block in the conjugated diene based copolymer is 5 to 10 wt %, preferred 8 to 10 wt %.

In one embodiment, the present invention provides the conjugated diene based rubber as described hereinabove, wherein the total amount of the first conjugated diene monomer units in the conjugated diene based copolymer is 3 to 10 wt %, preferred 5 to 8 wt %.

In one embodiment, the present invention provides the conjugated diene based rubber as described hereinabove, wherein when the first block comprises only the first conjugated diene monomer units and the second conjugated diene monomer units, the amount of the second conjugated diene monomer units in the first block is 35 to 40 wt % of the first block.

In one embodiment, the present invention provides the conjugated diene based rubber as described hereinabove, wherein the total amount of the vinyl aromatic hydrocarbon monomer units is 0 to 40 wt %, preferably 10 to 30 wt %, more preferably 12 to 28 wt %, in the conjugated diene based copolymer.

In one embodiment, the present invention provides the conjugated diene based rubber as described hereinabove, wherein when the first block comprises only the first conjugated diene monomer units and the vinyl aromatic hydrocarbon monomer units, the amount of the vinyl aromatic hydrocarbon monomer units in the first block is 35 to 40 wt % of the first block.

In one embodiment, the present invention provides the conjugated diene based rubber as described hereinabove, wherein the amount of the vinyl aromatic hydrocarbon monomer units in the second block is 0 to 40 wt %, preferably 10 to 30 wt %, more preferably 12 to 28 wt %, of the conjugated diene based copolymer.

In one embodiment, the present invention provides the conjugated diene based rubber as described hereinabove, wherein the total amount of the second conjugated diene monomer units is 50 to 95 wt %, preferably 60 to 85 wt %, of the conjugated diene based copolymer.

In one embodiment, the present invention provides the conjugated diene based rubber as described hereinabove, wherein the amount of the second conjugated diene monomer units in the second block is 50 to 95 wt %, preferably 60 to 85 wt %, of the conjugated diene based copolymer.

In one embodiment, the present invention provides the conjugated diene based rubber as described hereinabove, wherein the amount of the vinyl structure of the conjugated diene based copolymer is 20 to 70%, preferably 25 to 45%, of the whole conjugated diene based copolymer.

In one embodiment, the present invention provides the conjugated diene based rubber as described hereinabove, wherein the weight average molecular weight of the first block is ranged between 12,000 to 25,000.

In one embodiment, the present invention provides the conjugated diene based rubber as described hereinabove, wherein the weight average molecular weight of the second block is ranged between 150,000 to 350,000.

In one embodiment, the present invention provides the conjugated diene based rubber as described hereinabove, wherein the weight average molecular weight of the conjugated diene based copolymer is ranged between 500,000 to 750,000.

In one embodiment, the present invention provides the conjugated diene based rubber as described hereinabove, which is characterized in that the first block of the conjugated diene based copolymer is polymerized at 30˜90° C.

In one embodiment, the present invention provides the conjugated diene based rubber as described hereinabove, further comprising a modified conjugated diene based copolymer by modification of the conjugated diene based copolymer, wherein the modified conjugated diene based copolymer has a modified end, and wherein the modified end is more proximate to the second block of the modified conjugated diene based copolymer as compared to the first block of the modified conjugated diene based copolymer.

In one embodiment, the present invention provides the conjugated diene based rubber as described hereinabove, wherein the modified end is a silane structure, the silane structure selectively comprises the atom of nitrogen, oxygen, sulfur, or phosphorus.

In one embodiment, the present invention provides the conjugated diene based rubber as described hereinabove, wherein the conjugated diene based copolymer has M_{L 1+4} 100° C. ranging from 100 to 135.

In one embodiment, the present invention provides the conjugated diene based rubber as described hereinabove, comprising 70 parts by weight of the conjugated diene based copolymer and 60 to 80 parts by weight of SiO₂.

In one embodiment, the present invention provides a tire, where the tire is made from the conjugated diene based rubber as described hereinabove.

### Manufacturing Method for Conjugated Diene Based Copolymer

The present invention provides a manufacturing method for a conjugated diene based copolymer as described hereinabove, containing formation of the copolymer by anionic polymerization in the presence of an organic alkali metal, the conjugated diene based copolymer comprising at least two conjugated diene monomer units and optionally comprising a vinyl aromatic hydrocarbon monomer unit, the manufacturing method comprising the following steps: step a: polymerizing a first block of the conjugated diene based copolymer, the first block being composed of the first conjugated diene monomer unit and the vinyl aromatic hydrocarbon monomer unit or the second conjugated diene monomer unit, the second conjugated diene monomer unit being distinct from the first conjugated diene monomer unit, the first block being random, wherein the first conjugated diene monomer unit has a side chain absent in the second conjugated diene monomer unit and wherein the amount of the vinyl aromatic hydrocarbon monomer units or the second conjugated diene monomer units in the first block is at least 35 wt % of the first block; and step b: polymerizing a second block of the conjugated diene based copolymer, the second block comprising at least the second conjugated diene monomer unit and optionally comprising the vinyl aromatic hydrocarbon monomer unit.

The anionic polymerization refers to the formation of an activated carbon anion by using an initiator, and after the monomer is added, an addition polymerization reaction with the activated carbon anion is carried out to form a polymer having a negative charge at a chain end group, and then a terminator is added to terminate the reaction and thus obtain the polymer. At least any one of an alkali metal compound and an alkaline earth metal compound can be used as a polymerization initiator. Organic alkali metal compound includes monoorganic lithium compound, such as methyllithium, ethyllithium, n-propyllithium, isopropyllithium, n-butyllithium, sec-butyllithium, tert-butyllithium, isobutyllithium, n-pentyllithium, n-hexyllithium, benzyllithium, phenyllithium, tolyllithium and all isomers thereof, naphthyllithium, stilbenelithium; polyfunctional organic lithium compound, such as 1,4-dilithium butane, 1,5-dilithium pentane, 1,2-dilithium diphenylethane, 1,4-dilithium-1,1,4,4-tetraphenylbutane, 1,3- or 1,4-bis(1-lithium-3-methylpentyl)benzene, naphthalene dilithium, dilithium hexylbenzene, 1,4-dilithium-2-ethylcyclohexane, 1,3,5-trilithiumbenzene, 1,3,5-tris(lithiomethyl)benzene, reaction product of sec-butyllithium and diisopropenylbenzene, reaction product of n-butyllithium (or sec-butyllithium, tert-butyllithium, isobutyllithium) with 1,3-butadiene and divinylbenzene, reaction product of n-butyllithium (or sec-butyllithium, tert-butyllithium, isobutyllithium) and polyacetylene compounds; organic sodium compounds, such as sodium naphthyl; organic potassium compounds, such as potassium naphthyl and potassium ethoxide; compounds with nitrogen-lithium bonds (metal amide compounds), such as lithium dimethylamide, lithium dihexylamide, lithium diisopropylamide, and lithium hexamethyleneimide. The metal amide compound is preferably a reaction product of a lithium compound such as alkyllithium or aromatic lithium and a secondary amine compound. Examples of the secondary amine compound include dimethylamine, diethylamine, dipropylamine, dibutylamine, dihexylamine, dibenzylamine, dodecamethyleneimine, N,N′-Dimethyl-N′-trimethylsilyl-1,6-diaminohexane, piperidine, pyrrolidine, Hexamethyleneimine, Heptamethyleneimine, dicyclohexylamine, N-methylbenzylamine, di-(2-ethylhexyl)amine, diallylamine, morpholine, N-(trimethylsilyl)piperazine, N-(tert-butyldimethylsilyl)piperazine, 1,3-bistrimethylsilyl-1,3,5-triazinane, etc. Examples of organic alkaline earth metal compounds include di-n-butylmagnesium, di-n-hexyl magnesium, diethoxy calcium, calcium stearate, calcium distearate, di-tert-butoxy strontium, diethoxy barium, barium diisopropoxide, diethyl mercapto barium, barium di-tert-butoxide, barium diphenoxide, barium distearate, and diketyl barium, etc. These polymerization initiators can be used individually or in combination of two or more types. The initiator is preferably a lithium compound. The lithium compound is preferably n-butyllithium and sec-butyllithium.

With regard to the anionic polymerization, a suitable solvent is, for example, an inert organic solvent, which does not participate in the polymerization reaction. Such solvent comprises the aliphatic hydrocarbons, like butane, isobutane, n-pentane, isopentane, 2,2,4-trimethylpentane, isohexane, n-hexane, isoheptane, n-heptane, isooctane, n-octane, or n-decane; or cycloalkanes, like cyclohexane, methylcyclohexane, ethylcyclohexane, cyclopentane, cycloheptane, methylcyclopentane, or methylcycloheptane; or aromatic hydrocarbons, like benzene, toluene, xylene, ethylbenzene, diethylbenzene, or propylbenzene. These inert organic solvents can be used alone or in combination of two or more. What is suitable for use in the present invention is preferably cyclohexane.

In one embodiment, the present invention provides a manufacturing method for the conjugated diene based copolymer as described hereinabove, wherein the step a is performed in an organic solvent containing cyclic ethers or diethers. Specific examples of cyclic ethers or diethers suitable for the present invention include tetrahydrofuran, 2,2-bis(2-tetrahydrofuryl)propane, dimethyl ether, diethyl ether, dipropyl ether, dibutyl ether, cyclopentyl ether, and ethylene glycol dimethyl ether, ethylene glycol diethyl ether, ethylene glycol dibutyl ether, diethylene glycol dimethyl ether, diethylene glycol diethyl ether, diethylene glycol dibutyl ether, methyl ethyl ether, ethyl propyl ether, dimethoxybenzene and all its isomers, dimethoxyethane and all its isomers, 2-(diethoxy)-2-methylpropane, dioxane, dibenzyl ether, diphenyl ether, diethoxypropane, 1,2-diethoxyethane, 1,2-diphenoxyethane, N-methylmorpholine. These cyclic ethers or diethers can be used alone or in combination of two or more. The preferred selection of the cyclic ethers is tetrahydrofuran, the preferred selection of the diethers is ethylene glycol diethyl ether.

In one embodiment, the present invention provides a manufacturing method for the conjugated diene based copolymer as described hereinabove, wherein the organic alkali metal is not added in step b.

In one embodiment, the present invention provides a manufacturing method for the conjugated diene based copolymer as described hereinabove, wherein the step a comprises adding the organic alkali metal after mixing a first conjugated diene monomer and a vinyl aromatic hydrocarbon monomer or a second conjugated diene monomer.

In one embodiment, the present invention provides a manufacturing method for the conjugated diene based copolymer as described hereinabove, comprising performing the step a under 30˜90° C.

In one embodiment, the present invention provides a manufacturing method

for the conjugated diene based copolymer as described hereinabove, comprising performing the step b under 15˜105° C.

In one embodiment, the present invention provides a manufacturing method for the conjugated diene based copolymer as described hereinabove, wherein the step b further comprises adding an additional second conjugated diene monomer after adding the second conjugated diene monomer and the vinyl aromatic hydrocarbon monomer and reaching a temperature peak.

In one embodiment, the present invention provides a manufacturing method for the conjugated diene based copolymer as described hereinabove, further comprising a step c: adding a modifier to modify at least a portion of the conjugated diene based copolymer.

In one embodiment, the present invention provides a manufacturing method for the conjugated diene based copolymer as described hereinabove, wherein during the step a with reaction temperature between 45° C. to 90° C., there is a monomer conversion ratio of the first block greater than 90% at 30 minutes of reaction when the first block comprises only the first conjugated diene monomer unit and the vinyl aromatic hydrocarbon monomer unit.

In one embodiment, the present invention provides a manufacturing method for the conjugated diene based copolymer as described hereinabove, wherein during the step a with reaction temperature between 45° C. to 90° C., there is a monomer conversion ratio of the first block greater than 80% at 30 minutes of reaction when the first block comprise only the first conjugated diene monomer unit and the second conjugated diene monomer unit.

### Manufacturing Method for Conjugated Diene Based Rubber

The conjugated diene based copolymers of the present invention can be mixed with other components to obtain conjugated diene based rubbers. Examples of the other components include natural rubber, other conjugated diene polymers different from those of the present invention, ethylene-propylene copolymers and ethylene-octene copolymers. Suitable additives can be added, comprising vulcanizing agent such as sulfur; a vulcanization accelerator such as a thiazole-based vulcanization accelerator, a thiuram-based vulcanization accelerator, or a sulfenamide-based vulcanization accelerator; a vulcanization activator such as stearic acid or zinc oxide; an organic peroxide; a reinforcing agent such as silica or carbon black; a filler such as calcium carbonate or talc; a silane coupling agent; an extender oil; a processing aid; an antioxidant; and a lubricant.

Compounding method for the conjugated diene based rubber can be, for example, a method in which each component is kneaded by means of a known mixer such as a roll or a Banbury mixer or an internal mixer. With regard to kneading conditions, in addition to the vulcanizing agent or the vulcanization accelerator, when an additive, fillers, silica and/or other reinforcing agent are mixed, the kneading temperature is normally 50° C. to 200° C., and preferably 80° C. to 150° C. with two to three stages of kneading, and the kneading time is normally 30 secs to 20 mins, and preferably 1 min to 10 mins. When a vulcanizing agent or a vulcanization accelerator is combined, the kneading temperature is normally no greater than 100° C., and preferably room temperature to 90° C. A composition in which a vulcanizing agent or a vulcanization accelerator is combined may be used by carrying out a vulcanization treatment such as press vulcanization. The vulcanization temperature is normally 120° C.to 200° C., and preferably 140° C. to 180° C.

The conjugated diene based rubber and the conjugated diene based rubber composition/composite of the present invention are used for tires, soles, flooring materials, vibration isolating materials, etc., and are particularly suitably used for tires.

### Analysis Method

Monomer conversion ratio is calculated by monitoring the amount of monomer remaining in the reaction using Gas Chromatography (GC), wherein GC is the Agilent Technologies 7890B GC System with a split ratio of 50:1, the detector is a Flame Ionization Detector(FID) with a detector temperature of 250° C., an injection port temperature of 250° C., and a capillary column of Agilent 19091A-115. Wherein, the monomer conversion ratio refers to the monomer conversion ratio of the entire first block. Taking the first block with A-monomer unit and B-monomer unit as an example, the monomer conversion ratio is calculated according to the following formula based on the given residual amount of monomer A and residual amount of monomer B:

(((Total amount of monomer A added−residual amount of monomer A)+(Total amount of monomer B added−residual amount of monomer B))/(Total amount of monomer A added+total amount of monomer B added))×100%

The total conjugated diene monomer content of the conjugated diene polymer, the total vinyl aromatic hydrocarbon monomer content of the conjugated diene polymer, and the vinyl structure content based on the total conjugated diene monomer content of the conjugated diene polymer (Vinyl %, Vinyl in Bond Diene) are measured referring to the relevant measurement methods described in China patent No. CN103476815, wherein NMR is Bruker AV-500 (500 MHZ), the probe is a 5 mm double probe equipped with automatic frequency tuning device, the NMR operation software is TOPSPIN, and the solvent used is deuterated chloroform/tetramethylsilane (CDCl3/TMS).

Weight average molecular weight (Mw): Analysis was performed by Gel Permeation Chromatography (GPC) utilizing a Waters 1525 Binary HPLC Pump with a Waters 2414 Refractive Index Detector, wherein the eluent was tetrahydrofuran, the eluent flow rate was 1 ml/min.

Mooney Viscosity (ML₁₊₄, 100° C.): Using ALPHA Mooney MV 2000 model, the test method was ASTM D-1646.

Glass transition temperature (Tg, ° C.): The glass transition temperature of the polymers was determined by a Differential Scanning calorimeter (DSC) using a TA Instrument Q200 Differential Scanning calorimeter (DSC) with a scanning speed of 20° C./min under nitrogen and a scanning range of −90° C. to 100° C.

Tensile Strength at Break (Tb, Mpa): Measured in accordance with ASTM D412 using INSTRON model 33R4464.

Elongation Strength at Break (Eb, %): Measured in accordance with ASTM D412 using INSTRON model 33R4464.

Rolling Resistance (R.R.): Using the TA instrument ARES-G2 model in the strain sweep to measure the change of G′ and G″ of the specimen and obtain the value of tan & =G″/G′, where the sample temperature during scanning was 60° C., the range of the strain sweep was 0.1%˜10%, the scanning frequency was 1 Hz, and the 5.0% strain value was taken.

Abrasion test (DIN): The GT-7012-DN model was used for measuring in accordance with ASTM D5963.

Compound Mooney Viscosity (Cpd ML₁₊₄, 100° C.): ALPHA Mooney MV 2000 model was used, and the test method was ASTM D-1646.

### Examples of the Conjugated Diene Based Copolymers

### Example 1

Isoprene and styrene were mixed in a cyclohexane solution containing tetrahydrofuran and ethylene glycol diethyl ether to polymerize the first block. Then, n-butyllithium is added to the mixture and the reaction was carried out at 50° C.until the conversion ratio of isoprene and styrene reaches more than 99.9%, respectively (about 60 minutes). Butadiene and styrene were added for the polymerization of the second block. After reaching the maximum temperature for 5 minutes, a small amount of butadiene is added as an end, and the reaction is carried out for 5 minutes, followed by the addition of silicon-modifier (Diethyl[2-(triethoxysilyl)ethyl]phosphonate) and the reaction is carried out for 30 minutes, and then the reaction is terminated by the addition of methanol.

Example 2 refers to the method of Example 1, with the difference that the styrene of the first block polymerization was replaced by butadiene. Example 3 refers to the method of Example 1, but differs in that the reaction temperature of the first block polymerization was increased to 70° C. Example 4 refers to the method of Example 2, with the difference that the reaction temperature of the first block polymerization was increased to 70° C.

### Comparative Example 1

Comparative example 1 did not carry out the polymerization of the first block. n-butyl lithium was added in a cyclohexane solution containing tetrahydrofuran and ethylene glycol diethyl ether, followed by adding butadiene and styrene to carry out polymerization. After reaching the maximum temperature for 5 minutes, a small amount of butadiene is added as an end, and the reaction is carried out for 5 minutes, followed by the addition of silicon-modifier (Diethyl[2-(triethoxysilyl)ethyl]phosphonate) and the reaction is carried out for 30 minutes, and then the reaction is terminated by the addition of methanol.

### Comparative Example 2-3

Comparative Examples 2-3 refer to the method of Example 1, with the difference that only isoprene is used in the first block polymerization (no styrene and no butadiene). Comparative Example 3 refers to the method of Example 1, with the difference that the amount of styrene used in the first block polymerization is reduced. Comparative Example 2-1, Comparative Example 2-2, and Comparative Example 2-4 refer to the method of Comparative Example 2-3, with the difference that the reaction temperature for the first block polymerization in Comparative Example 2-3 is 50° C., whereas the reaction temperature in Comparative Example 2-1, Comparative Example 2-2, and Comparative Example 2-4 are 30° C., 40° C., and 70° C., respectively.

Table 1 shows the various conditions for the reactions of the above mentioned examples and the comparative examples. In this context, SM stands for styrene, BD stands for butadiene, and IPM stands for isoprene.

TABLE 1

| | | Examples | | | | Comparative Examples | | | | | |
|---|---|---|---|---|---|---|---|---|---|---|---|
| Rection Conditions | | 1 | 2 | 3 | 4 | 1 | 2-1 | 2-2 | 2-3 | 2-4 | 3 |
| cyclohexane(g) | | 5525 | 5525 | 5525 | 5525 | 5525 | 5525 | 5525 | 5525 | 5525 | 5525 |
| tetrahydrofuran(g) | | 10 | 10 | 8 | 8 | 10 | 10 | 10 | 10 | 10 | 10 |
| ethylene glycol diethyl | | 2.5 | 2.5 | 0.8 | 0.8 | 2.5 | 2.5 | 2.5 | 2.5 | 2.5 | 2.5 |
| ether (g) | | | | | | | | | | | |
| n-butyl lithium (mmole) | | 3.8 | 3.8 | 3.1 | 3.1 | 3.8 | 3.8 | 3.8 | 3.8 | 3.8 | 3.8 |
| The | IPM(g) | 45 | 45 | 45 | 45 | — | 45 | 45 | 45 | 45 | 45 |
| first | SM(g) | 27 | — | 27 | — | — | — | — | — | — | 9 |
| block | BD(g) | — | 27 | — | 27 | — | — | — | — | — | — |
| | Reaction Temp(° C.) | 50 | 50 | 70 | 70 | — | 30 | 40 | 50 | 70 | 50 |
| The | SM(g) | 216 | 243 | 108 | 135 | 189 | 243 | 243 | 243 | 135 | 234 |
| second | BD(g) | 581 | 554 | 684 | 657 | 675 | 581 | 581 | 581 | 684 | 581 |
| block | end BD(g) | 31 | 31 | 36 | 36 | 36 | 31 | 31 | 31 | 36 | 31 |
| | silicon-modifier | 21.3 | 21.3 | 21.3 | 21.3 | 21.3 | 21.3 | 21.3 | 21.3 | 21.3 | 21.3 |
| | (mmole) | | | | | | | | | | |

### Examples of the Conjugated Diene Based Rubbers

Perform hot-melt mixing in a suitable kneader according to Table 2 to obtain the conjugated diene based rubbers. The shape of the conjugated diene based rubbers is not particularly limited, and may be granular, sheet/film, strand, crumb, etc. The preferred embodiment of the present invention is that after kneading, it is pelletized with a pelletizer. Referring to Table 2, vulcanizable rubber is made into sheets using a two-roll machine and then further vulcanized to obtain vulcanized sheets.

TABLE 2

| | | Wt |
|---|---|---|
| Kneading Formulations | | parts(phr) |
| General | Each of the above examples or comparative | 70.0 |
| Kneading | examples of copolymers | |
| | Polybutadiene BR 0150 | 30.0 |
| | Silica | 70.0 |
| | TDAE oil | 37.5 |
| | silane | 11.2 |
| | stearic acid SA | 2.0 |
| | ZnO | 3.0 |
| | antioxidant (Santoflex 6PPD) | 1.0 |
| Vulcanizing | Sulfur powder | 1.5 |
| additives | N-Cyclohexyl-2-benzothiazole sulfenamide | 1.8 |
| | CBS | |
| | Diphenylguanidine DPG | 1.5 |

Table 3 presents various properties of the conjugated diene based copolymers and their rubbers obtained in Examples 1 to 4 of the present invention and the results of comparison with Comparative Example 1 and Comparative Examples 2-3. As shown in the table, the first block formed in Examples 1 to 4 is a random block of an isoprene monomer unit and a styrene monomer unit or a butadiene monomer unit, wherein the content of the styrene monomer unit or the butadiene monomer unit accounts for 37.5 wt % of the first block, and the reaction temperature of the first block in Examples 1 to 2 is 50° C., and that of the first block in Examples 3 to 4 is 70° C.

The viscosities (ML and Cpd ML) of Examples 1 to 4 were greater than those of Comparative Example 1 (without the first block) and Comparative Examples 2-3 (with the first block but not random, only containing isoprene monomer unit). Compared to Comparative Example 1 (without the first block), Examples 1-4 exhibit superior tensile strength at break (Tb), elongation at break (Eb), abrasion (DIN) and exhibit superior or similar rolling resistance (R.R.). Compared to Comparative Examples 2-3 (with a first block but not random, only containing isoprene monomer unit), Examples 1 to 4 exhibit superior abrasion (DIN) and rolling resistance (R.R.) and exhibit superior or similar tensile strength at break (Tb) and elongation at break (Eb). Comparative Examples 2-3 (with first block but not random, only containing isoprene monomer unit) have the worst rolling resistance (R.R.) of all the embodiments and comparative examples. In addition, Examples 3 to 4 exhibit excellent abrasion (DIN) and good tensile strength at break (Tb), elongation at break (Eb) and acceptable rolling resistance (R.R.) compared to Examples 1to 2.

TABLE 3

| | | | | | | Comparative | |
|---|---|---|---|---|---|---|---|
| | | Examples | | | | Examples | |
| Items | | 1 | 2 | 3 | 4 | 1 | 2-3 |
| The | IPM(wt %) | 5 | 5 | 5 | 5 | — | 5 |
| first | SM(wt %) | 3 | — | 3 | — | — | — |
| block | BD(wt %) | — | 3 | — | 3 | — | — |
| The | SM(wt %) | 24 | 27 | 12 | 15 | 21 | 27 |
| second | BD(wt %) | 63 | 60 | 75 | 72 | 74 | 63 |
| block | end BD(wt %) | 5 | 5 | 5 | 5 | 5 | 5 |

| | | | | | | |
|---|---|---|---|---|---|---|
| Reaction temperature of the first block | 50° C. | 50° C. | 70° C. | 70° C. | — | 50° C. |
| Ratio of SM or BD in the first block (wt %) | 37.5 | 37.5 | 37.5 | 37.5 | — | — |
| Ratio of the first block to the whole | 8 | 8 | 8 | 8 | — | — |
| copolymer (wt %) | | | | | | |
| Ratio of IPM to the whole copolymer | 5 | 5 | 5 | 5 | — | — |
| (wt %) | | | | | | |
| Ratio of SM to the whole copolymer | 27 | 27 | 15 | 15 | — | — |
| (wt %) | | | | | | |
| Ratio of SM of the second block to the | 24 | 27 | 12 | 15 | — | — |
| whole copolymer (wt %) | | | | | | |
| Ratio of BD to the whole copolymer (wt %) | 68 | 68 | 80 | 80 | — | — |
| Ratio of BD of the second block to the | 68 | 65 | 80 | 77 | — | — |
| whole copolymer (wt %) | | | | | | |
| Ratio of vinyl structure to the whole | 42 | 42 | 26 | 26 | — | — |
| copolymer (%) | | | | | | |
| Mw(10⁴) | 65 | 65 | 66 | 66 | 55 | 61 |
| ML₁₊₄100° C. | 98 | 96 | 104 | 103 | 75 | 88 |
| Tg (° C.) | −23 | −23 | −61 | −60 | −21 | −23 |
| Cpd ML (index) | 102 | 105 | 103 | 103 | 100 | 98 |
| Tb (index) | 112 | 111 | 108 | 109 | 100 | 110 |
| Eb (index) | 103 | 105 | 107 | 107 | 100 | 104 |
| DIN (index) | 105 | 108 | 212 | 210 | 100 | 99 |
| R.R. (index) | 103 | 104 | 100 | 101 | 100 | 95 |

Table 4 presents the results of the monomer conversion ratios of the first block of the conjugated diene based copolymers of Examples 1 to 3 of the present invention compared to Comparative Examples 2-1 to 2-4 and Comparative Example 3. As shown in the table, at the same 50° C., the monomer conversion ratio of first block of Examples 1 to 2 (the first block is the random block of isoprene monomer unit and styrene monomer unit or butadiene monomer unit) was better than that of Comparative Examples 2-3 (with first block but not random, containing only isoprene monomer unit) and Comparative Example 3 (with random first block but in a low content of styrene monomer unit, the amount of the styrene monomer units in the first block is 16.7 wt %). At the same 70° C., the monomer conversion ratio of the first block of Example 3 (the first block was a random block of isoprene monomer unit and styrene monomer unit) was better than that of Comparative Examples 2-4 (with first block but not random, containing only isoprene monomer unit). In addition, at the same 50° C., Example 1 (random block of isoprene monomer unit and styrene monomer unit for the first block) had a better monomer conversion ratio than Example 2 (random block of isoprene monomer unit and butadiene monomer unit for the first block).

TABLE 4

| | | Examples | | | Comparative examples | | | | |
|---|---|---|---|---|---|---|---|---|---|
| Items | | 1 | 2 | 3 | 2-1 | 2-2 | 2-3 | 2-4 | 3 |
| The | IPM(wt %) | 5 | 5 | 5 | 5 | 5 | 5 | 5 | 5 |
| first | SM(wt %) | 3 | — | 3 | — | — | — | — | 1 |
| block | BD(wt %) | — | 3 | — | — | — | — | — | — |
| The | SM(wt %) | 24 | 27 | 12 | 27 | 27 | 27 | 15 | 26 |
| second | BD(wt %) | 63 | 60 | 75 | 63 | 63 | 63 | 75 | 63 |
| block | end BD(wt %) | 5 | 5 | 5 | 5 | 5 | 5 | 5 | 5 |

| | | | | | | | | |
|---|---|---|---|---|---|---|---|---|
| Reaction temperature of the | 50° C. | 50° C. | 70° C. | 30° C. | 40° C. | 50° C. | 70° C. | 50° C. |
| first block | | | | | | | | |
| Monomer conversion ratio of | — | — | >99.5 | — | — | — | — | — |
| the first block with reaction at | | | | | | | | |
| 20 mins (%) | | | | | | | | |
| Monomer conversion ratio of | 96 | 84 | >99.9 | 71 | 77 | 81 | 95 | 66 |
| the first block with reaction at | | | | | | | | |
| 30 mins (%) | | | | | | | | |
| Monomer conversion ratio of | >99.9 | 97 | >99.9 | 86 | 92 | 97 | 99 | 97 |
| the first block with reaction at | | | | | | | | |
| 60 mins (%) | | | | | | | | |
| Ratio of SM or BD in the first | 37.5 | 37.5 | 37.5 | — | — | — | — | 16.7 |
| block (wt %) | | | | | | | | |

While the invention has been described by way of examples and in terms of preferred embodiments, it would be apparent to those skilled in the art to make various equivalent replacements, amendments and modifications in view of specification of the invention. Therefore, the scope of the appended claims should be accorded the broadest interpretation so as to encompass all such replacements, amendments and modifications without departing from the spirit and scope of the invention.

1. A conjugated diene based rubber comprising a conjugated diene based copolymer comprising at least two conjugated diene monomer units and optionally comprising a vinyl aromatic hydrocarbon monomer unit, wherein the conjugated diene based copolymer comprises:
a first block composed of a first conjugated diene monomer unit and the vinyl aromatic hydrocarbon monomer unit or a second conjugated diene monomer unit, the first conjugated diene monomer unit having a side chain absent in the second conjugated diene monomer unit, the first block being random; and
a second block, comprising at least the second conjugated diene monomer unit and optionally comprising the vinyl aromatic hydrocarbon monomer unit, wherein the first block is connected to the second block, and the amount of the vinyl aromatic hydrocarbon monomer units or the second conjugated diene monomer units is at least 35 wt % of the first block.

2. The conjugated diene based rubber of claim 1, wherein the side chain is an alkene or alkane with a carbon number equal to 3.

3. The conjugated diene based rubber of claim 1, wherein the first conjugated diene monomer unit is from isoprene, the second conjugated diene monomer unit is from butadiene and the vinyl aromatic hydrocarbon monomer unit is from styrene.

4. The conjugated diene based rubber of claim 1, wherein the percentage of the first block in the conjugated diene based copolymer is 5 to 10 wt %.

5. The conjugated diene based rubber of claim 1, wherein the total amount of the first conjugated diene monomer units in the conjugated diene based copolymer is 3 to 10 wt %.

6. The conjugated diene based rubber of claim 1, wherein when the first block comprises only the first conjugated diene monomer unit and the second conjugated diene monomer unit, the amount of the second conjugated diene monomer units in the first block is 35 to 40 wt % of the first block.

7. The conjugated diene based rubber of claim 1, wherein the total amount of the vinyl aromatic hydrocarbon monomer units is 0 to 40 wt % in the conjugated diene based copolymer.

8. The conjugated diene based rubber of claim 1, wherein when the first block comprises only the first conjugated diene monomer unit and the vinyl aromatic hydrocarbon monomer unit, the amount of the vinyl aromatic hydrocarbon monomer units in the first block is 35 to 40 wt % of the first block.

9. The conjugated diene based rubber of claim 1, wherein the amount of the vinyl aromatic hydrocarbon monomer units in the second block is 0 to 40 wt %.

10. The conjugated diene based rubber of claim 1, wherein the total amount of the second conjugated diene monomer units is 50 to 95 wt % of the conjugated diene based copolymer.

11. The conjugated diene based rubber of claim 1, wherein the amount of the second conjugated diene monomer units in the second block is 50 to 95 wt % of the conjugated diene based rubber.

12. A tire, where the tire is made from the rubber of claim 1.

13. A manufacturing method for a conjugated diene based copolymer, containing a formation by anionic polymerization in the presence of an organic alkali metal, the conjugated diene based copolymer comprising at least two conjugated diene monomer units and optionally comprising a vinyl aromatic hydrocarbon monomer unit, the manufacturing method comprising the following steps:
step a: polymerizing a first block of the conjugated diene based copolymer, the first block being composed of a first conjugated diene monomer unit and the vinyl aromatic hydrocarbon monomer unit or the second conjugated diene monomer unit, the first conjugated diene monomer unit having a side chain absent in the second conjugated diene monomer unit, the first block being random and wherein the amount of the vinyl aromatic hydrocarbon monomer units or the second conjugated diene monomer units in the first block is at least 35 wt % of the first block; and
step b: polymerizing a second block of the conjugated diene based copolymer, the second block comprising at least the second conjugated diene monomer unit and optionally comprising the vinyl aromatic hydrocarbon monomer unit.

14. The manufacturing method for the conjugated diene based copolymer of claim 13, wherein during the step a with reaction temperature between 45° C.to 90° C., there is a monomer conversion ratio of the first block greater than 90% at 30 minutes of reaction when the first block comprises only the first conjugated diene monomer unit and the vinyl aromatic hydrocarbon monomer unit.

15. The manufacturing method for the conjugated diene based copolymer of claim 13, wherein during the step a with reaction temperature between 45° C.to 90° C., there is a monomer conversion ratio of the first block greater than 90% at 30 minutes of reaction when the first block comprises only the first conjugated diene monomer unit and the second conjugated diene monomer unit.
